(19) United States
(12) Patent Application Publication
(10) Pub. No.: US 2026/0259967 A1
(43) Pub. Date: Sep. 3, 2026

(54) TERMINAL SERVICE MANAGEMENT SYSTEM USING FACE RECOGNITION

(71) Applicants: Ju Ho CHONG, Incheon (KR); Sun NAMKUNG, Incheon (KR)

(72) Inventors: Ju Ho CHONG, Incheon (KR); Sun NAMKUNG, Incheon (KR); Jin Woo CHONG, Incheon (KR); Jin Young CHONG, Incheon (KR)

(73) Assignees: Ju Ho CHONG, Incheon (KR); Sun NAMKUNG, Incheon (KR)

(21) Appl. No.: 19/162,960

(22) PCT Filed: Mar. 8, 2024
(86) PCT No.: PCT/KR2024/003022

§ 371 Date: Sep. 8, 2025

(30) Foreign Application Priority Data
Mar. 8, 2023 (KR) 10-2023-0030681

(51) Int. Cl. G06F 21/32; G06V 40/16; G06V 40/50

(52) U.S. Cl. CPC G06F 21/32; G06V 40/172; G06V 40/50

(57) ABSTRACT

A terminal service management system using face recognition includes: a user identification management unit configured to register and manage user identification information through face recognition; a terminal service management unit configured to register and manage terminal services provided in a terminal of a registered user; and an execution management unit configured to analyze service conditions among the terminal service information of an identified user and control execution of the terminal by determining whether the service conditions are satisfied.

### TECHNICAL FIELD

The present invention relates to a terminal service management system using face recognition, and more particularly, to a terminal service management system capable of providing various terminal services such as eyesight protection, application usage restriction, and text size adjustment through user identification using face recognition.

### BACKGROUND ART

In general, when children, students, or other protected users use a terminal, parental or guardian supervision is required.

For example, the protected user may access adult content, whereby the adult content may be executed. In addition, when the distance between the protected user and the terminal is excessively close, it may result in deterioration of the user's eyesight, or damage may occur due to unnecessary paid transactions performed by the protected user.

In order to solve such problems, conventional methods provide services such as content restriction for parental control, services for limiting viewing distance, and services for restricting paid transactions. However, since these services are set for the entire terminal regardless of user, it is very inconvenient in that the restriction must be released when unnecessary, and then registered again when required.

In particular, in the case of a terminal used in common, it is difficult to selectively provide restricted services only for a specific user such as a child. Even when services are restricted through ID authentication, if the ID is leaked, unrestricted use becomes possible, thereby resulting in insufficient actual protection for children.

### DETAILED DESCRIPTION OF THE INVENTION

### Technical Problem

The present invention has been devised to solve the above problems, and its purpose is to provide a terminal service management system using face recognition, wherein terminal services such as viewing restriction, distance restriction, and payment restriction are applied only to users whose faces have been recognized by the face recognition function.

### Technical Solution

To achieve the above purpose, a terminal service management system using face recognition according to the present invention comprises: a user identification management unit configured to register and manage user identification information through face recognition; a terminal service management unit configured to register and manage terminal services provided in a terminal of a registered user; and an execution management unit configured to analyze service conditions among the terminal service information of an identified user and control execution of the terminal by determining whether the service conditions are satisfied.

The user identification management unit comprises: a face recognition module for recognizing a user's face; an ID registration management module for registering and managing a facial ID by recognizing the user's face; and a guardian ID management module for mapping and managing the facial ID and a guardian ID; wherein the face recognition module comprises a camera sensor for recognizing the user's face and an identification program for extracting unique feature points from a facial image recognized by the camera sensor, identifying the user, and detecting distance.

The terminal service management unit comprises: a terminal service management module for managing terminal services to be provided to the user, and for registering and managing terminal services requested by the user or the user's guardian; and a terminal management module for registering and managing terminals in which the registered terminal services are executed; wherein the terminal services include a content restriction service according to the user's age, a distance restriction service for protecting the user's eyesight, and a payment restriction service for restricting the user's transactions.

The execution management unit comprises: a user tracking management module for determining in real time whether a user authenticated with a facial ID is using the terminal; a service condition management module for extracting the registered terminal services of the user authenticated with the facial ID and determining whether service conditions of the terminal services are satisfied; and an execution restriction module for notifying the user and restricting execution of the terminal if the service conditions of the terminal services are satisfied.

### Advantageous Effects of the Invention

As described above, the terminal service management system using face recognition according to the present invention provides the excellent effect that only users registered with a facial ID are subject to terminal services, thereby effectively blocking harmful content for children, protecting eyesight, and preventing unauthorized paid transactions.

In particular, even in a terminal used in common, the invention provides the outstanding effect that only a specific user can have registered terminal services executed through the face recognition function.

### BRIEF DESCRIPTION OF THE DRAWINGS

FIG. 1 is a schematic block diagram showing the configuration of a terminal service management system using face recognition according to a preferred embodiment of the present invention.

### BEST MODE FOR CARRYING OUT THE INVENTION

The terminal service management system using face recognition according to the present invention may comprise: a user identification management unit (10) configured to register and manage user identification information through face recognition; a terminal service management unit (20) configured to register and manage terminal services provided in a terminal of a registered user; and an execution management unit (30) configured to analyze service conditions among the user service information of an identified user and to control execution of the terminal by determining whether the service conditions are satisfied.

### Mode for Carrying Out the Invention

Hereinafter, a preferred embodiment of the present invention will be described in detail with reference to the accompanying drawings.

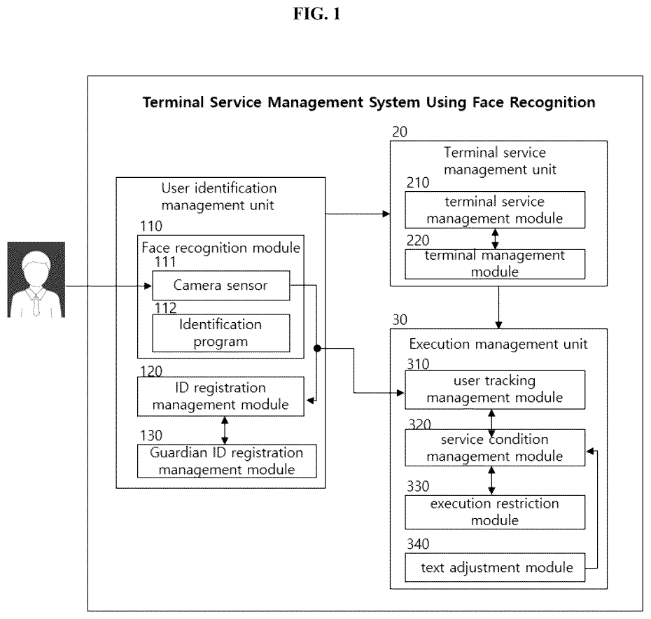

FIG. 1 is a schematic system configuration diagram showing a terminal service management system using face recognition according to a preferred embodiment of the present invention.

Referring to FIG. 1, the terminal service management system using face recognition according to the present invention may comprise: a user identification management unit (10) configured to register and manage user identification information through face recognition; a terminal service management unit (20) configured to register and manage terminal services provided in a terminal of a registered user; and an execution management unit (30) configured to analyze service conditions among the user service information of the identified user and to control execution of the terminal by determining whether the service conditions are satisfied.

The user identification management unit (10) may comprise: a face recognition module (110) for recognizing a user's face, an ID registration management module (120) for registering and managing a facial ID by recognizing the user's face, and a guardian ID management module (130) for mapping and managing the facial ID and a guardian ID.

The face recognition module (110) may comprise: a camera sensor (111) for recognizing a user's face, and an identification program (112) for extracting unique feature points from a facial image recognized by the camera sensor, identifying the user, and detecting a distance.

The camera sensor (111) may be a camera embedded in or installed on the terminal, and the identification program (112) may be implemented as a face recognition algorithm for analyzing a facial image and extracting unique identification information, and a distance detection algorithm for calculating a distance between the terminal and the user from the acquired facial image. Since the face recognition algorithm and distance detection algorithm are well known to those skilled in the art and are outside the core of the present invention, detailed description thereof will be omitted.

The facial ID refers to an identification code for recognizing a user's face and identifying the recognized face as facial information, which is unique identification information.

The ID registration management module (120) is responsible for mapping and registering user information when facial information is registered through the face recognition module (110). The user information may mean general information such as the user's name, age, and gender.

Accordingly, when the user's facial information is mapped with the user's information, the user can be identified and specified when the face is recognized.

The guardian ID management module (130) manages guardian information mapped with user information when a guardian applies for and registers a terminal service for the user.

That is, if registered as a guardian of the user through the guardian ID management module (130), the user's ID and facial ID may be mapped and managed, and the guardian may register terminal services for the user.

The terminal service management unit (20) is responsible for registering and managing terminal services provided to the registered user.

More specifically, the terminal service management unit (20) may comprise: a terminal service management module (210) for managing terminal services provided to the user and for registering terminal services requested by the user or the guardian, and a terminal management module (220) for registering and managing terminals in which the registered terminal services are executed.

The terminal service management module (210) manages terminal services provided to the user. Such terminal services may be defined as services requiring the assistance and control of a guardian, such as restricting access to adult content, eyesight protection, and payment restriction.

The terminal services may include: a content restriction service according to the age of the user, a distance restriction service for protecting the user's eyesight, and a payment restriction service for restricting the user's payments.

When a request for registration of such a terminal service is made from the user or guardian, the terminal service management module (210) provides an interface for selecting options of the terminal service, and registers and manages the terminal service for the specific user.

The options may be set in various ways depending on the type and characteristic of the terminal service.

If the terminal service is a content restriction service, it blocks the user's access to adult content or blocks adult content from being displayed on the terminal.

For example, when a user logs in through a facial ID and attempts to access adult content while using the terminal, the service may recognize the user's face and block access.

In conventional adult authentication, once adult authentication is performed, subsequent access to adult content cannot be blocked. Therefore, if authentication is done with the guardian's ID, adult content access cannot be blocked. However, the present invention authenticates by facial ID and checks the user's face information in real time, thereby fundamentally preventing circumvention of adult content access.

If the terminal service is a distance restriction service, when the distance between the terminal and the user is within a preset range, an alarm is generated or the screen is switched to a power-saving mode so that the user maintains a proper distance from the terminal.

If the terminal service is a payment restriction service, when the user attempts a paid transaction through the terminal, the service may recognize the user's face and block the paid transaction.

The terminal management module (220) registers and manages terminals in which the registered terminal services are executed.

The terminals may include PCs such as computers or laptops, smart TVs in which cameras are embedded or installed, as well as portable terminals such as mobile phones, and all display devices capable of accessing the Internet.

In general, except for personal terminals such as mobile phones, computers and smart TVs may be used in common by family members. Therefore, when managing terminals in which terminal services are provided, only the registered user's face may be recognized and terminal services may be provided only to the specific user.

The terminal service management system using face recognition according to the present invention may be installed and managed in the form of an application in a terminal, and in order for the terminal services to be provided, the application must be installed in the designated terminal.

Meanwhile, the execution management unit (30) is responsible for analyzing service conditions among the user's terminal service information and determining whether the service conditions are satisfied, thereby controlling execution of the terminal.

The execution management unit (30) may comprise: a user tracking management module (310) for determining in real time whether a user authenticated by facial ID is using the terminal; a service condition management module (320) for extracting registered terminal services of the user authenticated by facial ID and determining whether service conditions of the terminal services are satisfied; and an execution restriction module (330) for notifying the user and restricting the execution of the terminal when the service conditions of the terminal services are satisfied.

The user tracking management module (310) tracks whether a user authenticated with facial ID is using the terminal, by having the face recognition module (110) analyze the user's face in real time.

The service condition management module (320) determines whether the service conditions are satisfied depending on the registered terminal service. The service conditions may be defined as conditions that restrict execution of the terminal services.

If the terminal service is a content restriction service, the service condition is satisfied when the content to be accessed is adult content, or when the keyword entered by the user is related to adult content.

If the terminal service is a distance restriction service, the service condition is satisfied when the distance between the user's face and the terminal is within a preset distance.

The preset distance may differ depending on the type of terminal: for example, 50 cm for a portable terminal, 1 m for a computer terminal, and 3 m for a smart TV.

For example, if the option for the distance restriction service is set to 1 m, the service condition is satisfied when the distance detected by the face recognition module (110) is within 1 m.

The distance between the terminal and the user's face may be calculated from the acquired image through the face recognition and distance estimation algorithm of the face recognition module (110).

Accordingly, while checking whether the facial ID matches the user's face, the system can measure the distance between the terminal and the user and determine whether it is within the preset distance, which is the service condition.

If the terminal service is a payment restriction service, the service condition is satisfied when the user attempts to use paid content or attempts a paid transaction through games or online shopping malls.

The execution restriction module (330) generates an alarm and restricts the execution of the terminal when the service condition is satisfied for the registered terminal service.

If the terminal service is a content restriction service, when the user attempts to access adult content, an alarm indicating that adult content access is not available is generated, and execution of the adult content is blocked.

If the terminal service is a distance restriction service, when the user is detected within the preset distance, an alarm for eyesight protection is generated to prompt the user to move away from the terminal. If the user remains within the preset distance even after the alarm during the preset grace time, the screen is switched to a power-saving mode to restrict execution.

The preset grace time may be set to 5 seconds, 10 seconds, etc., to allow the user to move away from the preset distance.

The execution restriction module (330) may store history information according to the distance restriction service, and may be configured to change the preset distance through smart control by analyzing history information of restrictions.

For example, if the change criterion is set to 10 alarms per day, and alarms occur more than 10 times in a day, the preset distance may be extended to strengthen the distance restriction function.

If the terminal service is a payment restriction service, when the user attempts a paid transaction, an alarm indicating that paid transactions are not available is generated, and the paid transaction is blocked.

Since the service restriction is performed by comparing the facial image obtained in real time with the user's facial ID, execution can only be performed for the registered user, and application to other users is excluded, thus enabling a more convenient provision of terminal services.

In addition, the terminal service may include a service for automatically adjusting the size of text output on the terminal according to the distance between the terminal and the user's face.

To this end, the execution management unit (30) may further comprise a text adjustment module (340) for adjusting the text size.

The text adjustment module (340) automatically controls the text size according to the distance between the terminal and the user's face when text is being output on the terminal and the output text size is adjustable.

The execution management unit (30) identifies the user through the obtained facial ID, and if the identified user has preset text conditions, the text adjustment module (340) compares the text conditions with the distance between the terminal and the user's face, extracts the appropriate text size, and adjusts the text size accordingly.

The text conditions may be set differently depending on the user's eyesight, and may be set such that the text size increases as the distance between the terminal and the user's face increases, or in the case of myopia or presbyopia, the text size may be set to increase when the distance becomes closer.

Accordingly, the text conditions may be set according to the user's eyesight information, and the text adjustment module (340) may comprise a text extraction algorithm capable of extracting the optimal text size according to the eyesight information, so as to extract and provide the optimal text size according to the preset text conditions.

For example, in the case of a mobile phone terminal, the text extraction algorithm may set the text conditions as follows: if eyesight is 1.0 or higher, no text adjustment is required; if eyesight is between 0.5 and 0.9, enlarge the text when the distance between the terminal and the face exceeds 50 cm; if presbyopia, enlarge the text when the distance between the terminal and the face is within 20 cm.

The optimal text size according to eyesight and distance may be stored in a library, and when the user's eyesight information is input, the text condition may be set to the optimal text size according to the distance.

Although the detailed description above has been given with reference to a preferred embodiment of the present invention, the scope of protection of the present invention is not limited thereto. It will be understood by those skilled in the art that various modifications and changes can be made within the spirit and scope of the present invention without departing from its essence.

### Industrial Applicability

The present invention relates to a terminal service management system using facial recognition, and more particularly, to a system capable of providing various terminal services such as eyesight protection and application usage restriction through user identification based on facial recognition.

1. A terminal service management system using face recognition according to the present invention comprises:
a user identification management unit configured to register and manage user identification information through face recognition;
a terminal service management unit configured to register and manage terminal services provided in a terminal of a registered user; and
an execution management unit configured to analyze service conditions among the terminal service information of an identified user and control execution of the terminal by determining whether the service conditions are satisfied.

2. A terminal service management system using face recognition according to claim 1, wherein the user identification management unit comprises:
a face recognition module for recognizing a user's face;
an ID registration management module for registering and managing a facial ID by recognizing the user's face; and
a guardian ID management module for mapping and managing the facial ID and a guardian ID;
wherein the face recognition module comprises a camera sensor for recognizing the user's face and an identification program for extracting unique feature points from a facial image recognized by the camera sensor, identifying the user, and detecting distance.

3. A terminal service management system using face recognition according to claim 2, wherein the terminal service management unit comprises:
a terminal service management module for managing terminal services to be provided to the user, and for registering and managing terminal services requested by the user or the user's guardian; and
a terminal management module for registering and managing terminals in which the registered terminal services are executed;
wherein the terminal services include a content restriction service according to the user's age, a distance restriction service for protecting the user's eyesight, and a payment restriction service for restricting the user's transactions.

4. A terminal service management system using face recognition according to claim 2, wherein the execution management unit comprises:
a user tracking management module for determining in real time whether a user authenticated with a facial ID is using the terminal;
a service condition management module for extracting the registered terminal services of the user authenticated with the facial ID and determining whether service conditions of the terminal services are satisfied; and
an execution restriction module for notifying the user and restricting execution of the terminal if the service conditions of the terminal services are satisfied.

5. A terminal service management system using face recognition according to claim 4, wherein the execution management unit may further comprise;
a text adjustment module for automatically controlling the font size of text output on the terminal according to the distance between the terminal and the user's face, when the output text is adjustable in size.
